(19) United States
(12) Patent Application Publication
(10) Pub. No.: US 2013/0334776 A1
(43) Pub. Date: Dec. 19, 2013

(54) MACHINE HOUSING HAVING A CONDUCTOR SEAL SYSTEM

(71) Applicant: Paul Martin Dedrich, Auburn, IN (US)

(72) Inventor: Paul Martin Dedrich, Auburn, IN (US)

(73) Assignee: REMY TECHNOLOGIES, L.L.C., Pendleton, IN (US)

(21) Appl. No.: 13/495,519

(22) Filed: Jun. 13, 2012

(51) Int. Cl. F16J 15/02

(52) U.S. Cl. 277/637

(57) ABSTRACT

A machine housing includes a conductor seal system including an outer seal member and an inner seal member. The outer seal member has an outer seal body formed from a first material. The outer seal body includes an outer surface portion and an inner surface portion defining a central opening. The outer surface portion includes a housing gripping portion and the inner surface portion includes at least one retention feature arranged within the central opening. The inner seal member includes an inner seal body formed from a second material. The inner seal body includes an outer surface having at least one retaining element configured and disposed to engage with the at least one retention feature to join the inner seal member to the outer seal member to establish a water proof and dust proof seal at the opening extending through the housing body.

### BACKGROUND OF THE INVENTION

Exemplary embodiments pertain to the art of machines and, more particularly, to a conductor seal system for a machine housing.

Many machines include a housing that surrounds electrical components. The electrical components often times require a connection to a remote power source, or a signal connection with another machine. In such cases, conductors are passed through the housing to connect with one or more of the electrical components. In some cases, the machine is placed in a harsh operating environment. For example, the housing may be exposed to water or dust. It is generally desirable to limit water and/or dust from entering the housing. In such cases, the conductors are surrounded by a seal member that is mounted to the housing.

### BRIEF DESCRIPTION OF THE INVENTION

Disclosed is a machine housing including a housing body having an outer surface and an inner surface, and an opening extending from the outer surface through the inner surface. A conductor seal system including an outer seal member and an inner seal member is disposed in the opening. The outer seal member has an outer seal body formed from a first material. The outer seal body includes an outer surface portion and an inner surface portion defining a central opening. The outer surface portion includes a housing gripping portion and the inner surface portion includes at least one retention feature arranged within the central opening. The inner seal member includes an inner seal body formed from a second material. The inner seal body includes an outer surface having at least one retaining element configured and disposed to engage with the at least one retention feature to join the inner seal member to the outer seal member to establish a water proof and dust proof seal at the opening extending through the housing body.

Also disclosed is a conductor seal system including an outer seal member having an outer seal body formed from a first material. The outer seal body includes an outer surface portion and an inner surface portion defining a central opening. The outer surface portion includes a housing gripping portion and the inner surface portion includes at least one retention feature arranged within the central opening. An inner seal member includes an inner seal body formed from a second material. The inner seal body includes an outer surface having at least one retaining element configured and disposed to engage with the at least one retention feature to join the inner seal member to the outer seal member to establish a water proof and dust proof seal at the opening extending through the housing body.

### BRIEF DESCRIPTION OF THE DRAWINGS

The following descriptions should not be considered limiting in any way. With reference to the accompanying drawings, like elements are numbered alike:

FIG. 1 depicts a machine having a conductor seal system in accordance with an exemplary embodiment;

FIG. 2 depicts a plan view of the conductor seal system of FIG. 1;

FIG. 3 depicts a plan view of an outer seal member of the conductor seal system of FIG. 2; and

FIG. 4 depicts a plan view of an inner seal member of the conductor seal system of FIG. 2.

### DETAILED DESCRIPTION OF THE INVENTION

A detailed description of one or more embodiments of the disclosed apparatus and method are presented herein by way of exemplification and not limitation with reference to the Figures.

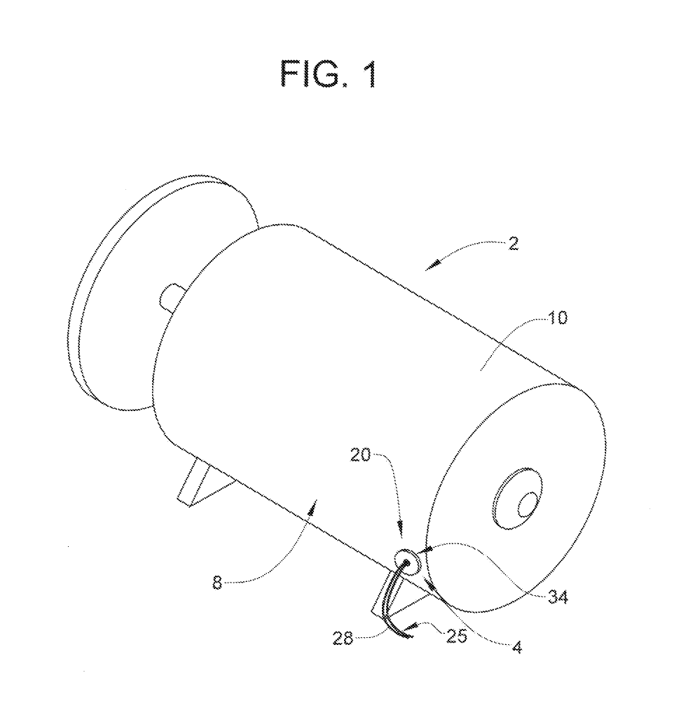

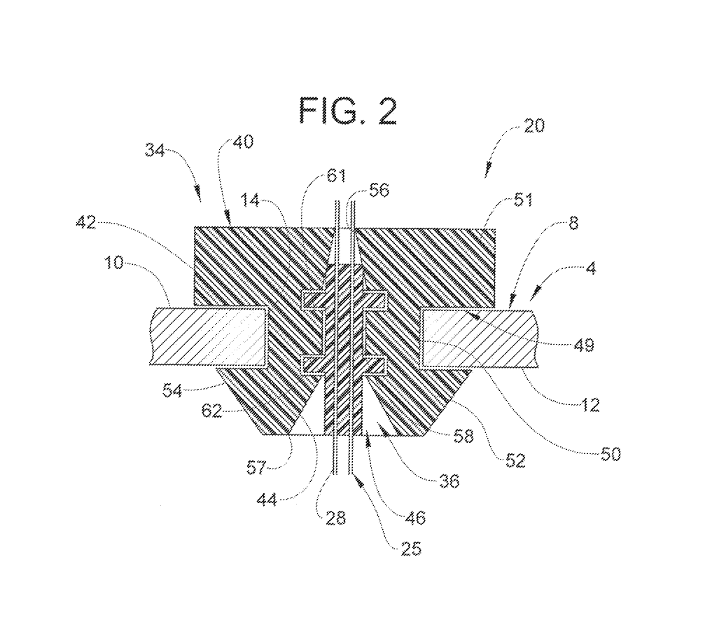

An electric machine constructed in accordance with an exemplary embodiment is indicated at 2 in FIGS. 1 and 2. Electric machine 2 includes a machine housing 4 having a housing body 8. Housing body 8 includes an outer surface 10 and an inner surface 12. An opening 14 extends from outer surface 10 through inner surface 12. Opening 14 is provided with a conductor seal system 20 that provides a water proof and/or dust proof seal for a conductor 25 passing into machine housing 4. Conductor 25 is shown to take the form of electrical wires 28 that may carry electrical power or control signals to machine 2. However, it should be understood that conductor 25 may take on a variety of forms including elements that deliver fluid, gas, light, or the like to machine 2.

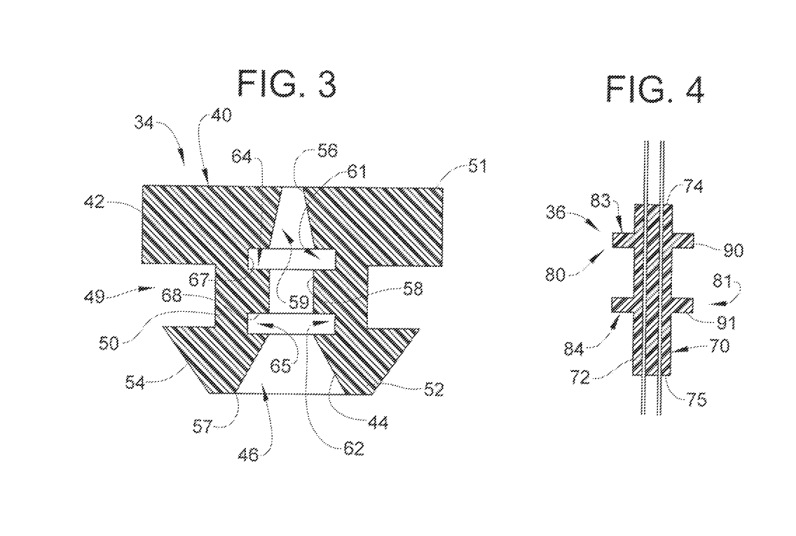

As shown in FIGS. 2-3, conductor seal system 20 includes an outer seal member 34 that matingly engages with an inner seal member 36. Outer seal member 34 includes an outer seal body 40 having an outer surface portion 42 and an inner surface portion 44 that defines a central passage 46. Outer surface portion 42 includes a housing gripping portion 49 defined by a central annular groove or recess 50. Central recess 50 establishes an upper section 51 and a lower section 52 of outer seal member 34. Lower section 52 includes a generally tapered surface profile 54 that facilitates insertion into opening 14. Inner surface portion 44 includes a first end 56 that extends from upper section 51 to a second end 57 that terminates at lower section 52. Inner surface portion 44 includes an inner wall 58 having a taper 59 that gradually increases from first end 56 to second end 57. Inner surface portion 44 also includes first and second retention features 61 and 62. Each retention feature 61, 62 includes a corresponding recess 64 and 65 that extends into outer seal member 34 from inner surface portion 44. In accordance with one aspect of the exemplary embodiment, each recess 64, 65 defines a corresponding generally annular ring 67, 68 having a generally rounded cross-sectional profile. Of course, it should be understood that annular rings 67 and 68 may have other geometries.

As shown in FIG. 4, inner seal member 36 includes an inner seal body 70 having an outer surface 72 that extends from a first end portion 74 to a second end portion 75. In the exemplary embodiment shown, inner seal body 70 is over molded onto conductors 25. Of course it should be understood that inner seal body 70 may also include an internal passage (not shown) for receiving conductors 25. When provided with an internal passage, conductors 25 are sealed to inner seal body 70 with an adhesive such as an epoxy or the like. Inner seal member 36 includes a first retaining element 80 and a second retaining element 81 formed on outer surface 72. First and second retaining elements 80 and 81 are spaced one from another between first and second end portions 74 and 75. In accordance with one aspect of the exemplary embodiment, first and second retaining elements 80 and 81 take the form of raised ribs 83 and 84 that project radially outward from outer surface 72. In accordance with another aspect of the exemplary embodiment, raised ribs 83 and 84 take the form of annular flanges 90 and 91 having a generally rectangular cross-sectional profile. However, it should be understood that raised ribs 83 and 84 need not extend continuously about outer surface 72.

Inner seal member 36 is configured to be inserted into central passage 46 of outer seal member 34. When fully inserted, first and second retaining elements 80 and 81 are received by and nest within first and second retaining features 61 and 62. Retaining elements 80 and 81 cooperate with corresponding ones of retaining features 61 and 62 to secure inner seal member 36 to outer seal member 34. In addition to providing a desired retention, retaining elements 80 and 81 and retaining features 61 and 62 provide a desired water and dust proofing about conductors 25 as will be further detailed below.

In further accordance with exemplary aspects, outer seal member 34 is formed from a material having a durometer of between about 30-A and about 50-A. In accordance with another aspect, outer seal member 34 is formed from a material having a durometer of about 40-A. In contrast, inner seal member 36 is formed from a material having a durometer of between about 70-A and about 90-A. In accordance with another aspect, inner seal member 36 is formed from a material having a durometer of about 80-A. In this manner, inner seal member 36 is less flexible than outer seal member 34 to facilitate insertion. In addition, the particular durometer property of outer seal member 34 enhances water and dust proofing properties of seal system 20. Specifically, outer seal member 34 is formed from a pliable material that envelops and seals against inner seal member 36 to substantially prevent water and/or dust passing into machine housing 4 through opening 14 while at the same time providing a passage for conductors 25.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A machine housing comprising:
a housing body having an outer surface and an inner surface, and an opening extending from the outer surface through the inner surface; and
a conductor seal system including an outer seal member and an inner seal member is disposed in the opening, the outer seal member having an outer seal body formed from a first material, the outer seal body including an outer surface portion and an inner surface portion defining a central opening, the outer surface portion including a housing gripping portion and the inner surface portion including at least one retention feature arranged within the central opening, the inner seal member including an inner seal body formed from a second material, the inner seal body including an outer surface having at least one retaining element configured and disposed to engage with the at least one retention feature to join the inner seal member to the outer seal member to establish a water proof and dust proof seal at the opening extending through the housing body.

2. The machine housing according to claim 1, wherein the at least one retention feature includes at least one recess extending from the central opening into the outer seal body.

3. The machine housing according to claim 2, wherein the at least one recess includes first and second recesses.

4. The machine housing according to claim 2, wherein the at least one recess comprises an annular ring.

5. The machine housing according to claim 2, wherein the at least one recess includes a generally rounded cross-sectional profile.

6. The machine housing according to claim 2, wherein the at least one retaining element includes at least one rib projecting radially outward from the outer surface of the inner seal member.

7. The machine housing according to claim 6, wherein the at least one rib comprises an annular flange.

8. The machine housing according to claim 6, wherein the at least one rib includes a generally rectangular cross-sectional profile.

9. The machine housing according to claim 1, wherein the first material includes a durometer of between about 30-A and about 50-A.

10. The machine housing according to claim 9, wherein the first material includes a durometer of about 40-A.

11. The machine housing according to claim 1, wherein the second material includes a durometer of between about 70-A and about 90-A.

12. The machine housing according to claim 11, wherein the second material includes a durometer of about 80-A.

13. The machine housing according to claim 1, wherein the housing gripping portion comprises an annular recess formed in the outer surface portion of the outer seal body.

14. The machine housing according to claim 1, wherein the inner surface portion includes a taper that defines the central opening.

15. The machine housing according to claim 1, wherein the inner seal body is over molded onto a conductor.

16. The machine housing according to claim 15, wherein the conductor comprises a wire configured and disposed to conduct electricity.

17. A conductor seal system comprising:
an outer seal member having an outer seal body formed from a first material, the outer seal body including an outer surface portion and an inner surface portion defining a central opening, the outer surface portion including a housing gripping portion and the inner surface portion including at least one retention feature arranged within the central opening; and
an inner seal member including an inner seal body formed from a second material, the inner seal body including an outer surface having at least one retaining element configured and disposed to engage with the at least one retention feature to join the inner seal member to the outer seal member to establish a water proof and dust proof seal at the opening extending through the housing body.

18. The machine housing according to claim 17, wherein the at least one retention feature includes first and second recesses, each of the first and second recesses having a generally rounded cross-sectional profile.

19. The machine housing according to claim 17, wherein the at least one retaining element includes first and second flanges projecting radially outward from the outer surface of the inner seal member each of the first and second flanges having a generally rectangular cross-sectional profile.

20. The machine housing according to claim 17, wherein the first material includes a durometer of between about 30-A and about 50-A and the second material includes a durometer of between about 70-A and about 90-A.
